(19) United States
(12) Patent Application Publication
(10) Pub. No.: US 2025/0326306 A1
(43) Pub. Date: Oct. 23, 2025

(54) FRUSTOCONICAL RECEIVER AND TRANSMITTER COILS FOR INDUCTIVE CHARGING OF LIGHT ELECTRIC VEHICLES

(71) Applicant: Wireless PNC Inc., Victoria (CA)

(72) Inventors: Mohammed Fahim, Toronto (CA); Spencer Steele, Victoria (CA); Paul Graham, Vancouver (CA)

(73) Assignee: Wireless PNC Inc., Victoria, BC (CA)

(21) Appl. No.: 18/638,559

(22) Filed: Apr. 17, 2024

(51) Int. Cl. B60L 53/12; H01F 5/00; H01F 5/02; H01F 5/06; H02J 7/00; H02J 50/00

(52) U.S. Cl. CPC B60L 53/12; H01F 5/02; H01F 5/06; H02J 7/0042; H01F 2005/006; H02J 50/005

(57) ABSTRACT

A pair of coils for use in inductive charging of a light electric vehicle, the pair of coils comprising a first frustoconical coil and a second frustoconical coil, wherein the first frustoconical coil defines an interior which is sized to accept the second frustoconical coil.

### FIELD

The present technology is a combination of an induction charging station for light electric vehicles (LEVs) and the LEV. More specifically it is an induction charging station that includes a frustoconical transmitter coil and an LEV with a frustoconical receiver coil that nests in the frustoconical transmitter coil.

### BACKGROUND

U.S. Pat. No. 10,418,840 discloses an inductive charger comprising an inductive charging coil for providing energy to an inductive receiving coil; and a fuel cell configured to provide electricity to the inductive charging coil. The housing for the charging coil may be conical, allowing for the charging coil to be moved along the housing to an be associated with regions of the cone shaped housing that have different circumferences. There is no teaching or contemplating of a frustoconical pair of coils that releasably mate.

United States Patent Application Publication No. 20190001829 discloses an inductive charging system for a vehicle having an electrical storage unit, in particular, an electric vehicle and a method of using the inductive charging system are provided. The inductive charging system preferably has a first coil device for a charging station and a second coil device for mounting on a vehicle, wherein the second coil device is preferably designed to magnetically interact with the first coil device. Furthermore, the inductive charging system preferably has a first positioning device, which movably supports the first coil device, wherein the system is preferably designed to produce an attractive magnetic force between the first coil device and the second coil device, which magnetic force causes a defined orientation of the first coil device in relation to the second coil device by the positioning unit. It is further disclosed that the first positioning device is in the form of centering studs and centering recesses. In a further advantageous design, the geometric positioning assistance means (positioning device) is realized as at least one cone or truncated cone and at least one cone cavity or truncated-cone cavity. In particular, in this case the centering studs, cones or truncated cones are provided on the first or second coil means, and the centering recesses, cone cavity or truncated-cone cavity are provided correspondingly, as a counter-piece, on the second or first coil means. There is no teaching or contemplating of a frustoconical pair of coils that releasably mate.

What is needed is an inductive charging pair in which the flux leakage is minimized. It would be preferable if the shape of the coils facilitated easy alignment of the transmitting and receiving coil. It would be further preferable if one coil is a first frustoconical cone and the other coil is a second frustoconical coil wherein the first frustoconical coil releasably mates with a the second frustoconical coil. It would be preferable if there was a locking mechanism.

### SUMMARY

Provided is an inductive charging pair in which the flux leakage is minimized. The shape of the coils of the inductive charging pair facilitates easy alignment of the transmitting and receiving coil. One coil is a first frustoconical cone and the other coil is a second frustoconical coil wherein the first frustoconical coil releasably mates with the second frustoconical coil, as a male-female connection. There is also a locking mechanism, which is a second mating pair, with a first member in a receiver module and the second member located in recess of a transmitter module.

In one embodiment, a pair of coils is provided for use in inductive charging of a light electric vehicle, the pair of coils comprising a first frustoconical coil and a second frustoconical coil, wherein the first frustoconical coil defines an interior which is sized to accept the second frustoconical coil.

In the pair of coils, the first frustoconical coil may include a liner and a spindle attached to the liner and extending into the interior and the second frustoconical coil may include a frustoconical outer body which includes a front end, the front end defining an aperture with a bore extending therefrom, the frustoconical outer body sized to be accepted by the second frustoconical coil and the aperture and bore sized to accept the spindle.

In the pair of coils, the spindle may include a spindle sheath which includes a circumferential groove, a plunger which is slidably housed in the spindle sheath and includes circumferentially disposed apertures, a plurality of balls which are releasably housed in the circumferential groove and which are sized to partially extend through the apertures and a spring which biases the plunger from the spindle sheath.

In the pair of coils, the bore may include a circumferential groove which is sized to accept the plurality of balls.

In another embodiment, a combination of a light electric vehicle and a charging station is provided, wherein: the light electric vehicle includes a receiver module, the receiver module comprising a frustoconical insulating body and a frustoconical receiver coil which is housed in the frustoconical insulating body; and the charging station comprising a housing which defines a recess, a transmitter module which is housed in the recess and includes a liner and a frustoconical or conical transmitter coil which is housed in the liner and defines an interior, the interior sized to accept the receiver module.

In the combination, the housing of the charging station may define a slot for accepting at least a portion of the light electric vehicle such that the receiver module can be mated with the transmitter module.

In the combination, the light electric vehicle may include a steering tube and receiver module mounted on the steering tube.

In the combination, the transmitter module may further include a spindle which is attached to the liner and extends into the interior and the receiver module includes a front end which defines an aperture with a bore extending therefrom, the aperture and bore sized to accept the spindle.

In the combination, the spindle may include a spindle sheath which includes a circumferential groove, a plunger which is slidably housed in the spindle sheath and includes circumferentially disposed apertures, a plurality of balls which are releasably housed in the circumferential groove and which are sized to partially extend through the apertures and a spring which biases the plunger from the spindle sheath.

In the combination, the bore may include a circumferential groove which is sized to accept the plurality of balls.

In another embodiment, a method of charging a light electric vehicle is provided, the method comprising: a user selecting a light electric vehicle including a battery and a frustoconical receiver module, the frustoconical receiver module including a frustoconical receiver coil which is in electrical communication with the battery; the user selecting a charging station, the charging station including a housing which defines a recess, a transmitter module which is housed in the recess and includes a liner and a frustoconical or conical transmitter coil which is housed in the liner and defines an interior, the interior sized to accept the receiver module; the user sliding the receiver module into the transmitter module; and the charging station powering the frustoconical or conical transmitter coil, thereby charging the battery of the light electric vehicle.

The method may further comprise locking the receiver module to the transmitter module prior to charging the battery of the light electric vehicle.

The method may further comprise unlocking the receiver module from the transmitter module after charging the battery of the light electric vehicle.

### BRIEF DESCRIPTION OF THE DRAWINGS

FIG. 1 is a perspective view of the combination of the charging station and the LEV of the present technology.

FIG. 2 is a cross sectional view of one embodiment of the receiver module.

FIG. 3 is a cross sectional view of one embodiment of the transmitter module.

FIG. 4 is a cross sectional view of an alternative embodiment of the receiver module.

FIG. 5 is a cross sectional view of an alternative embodiment of the transmitter module.

FIG. 6A is a cross sectional view of the receiver module and transmitter module of FIGS. 2 and 3 when engaged; and FIG. 6B is a cross sectional view of the receiver module and transmitter module of FIGS. 4 and 5 when engaged.

FIG. 7 is a graph showing the flux leakage acquired using Ansys Maxwell software.

FIG. 8A is a longitudinal sectional view of the locking mechanism in the locked position; and FIG. 8B is a longitudinal section view of the locking mechanism in the unlocked position.

### DESCRIPTION

Except as otherwise expressly provided, the following rules of interpretation apply to this specification (written description and claims): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

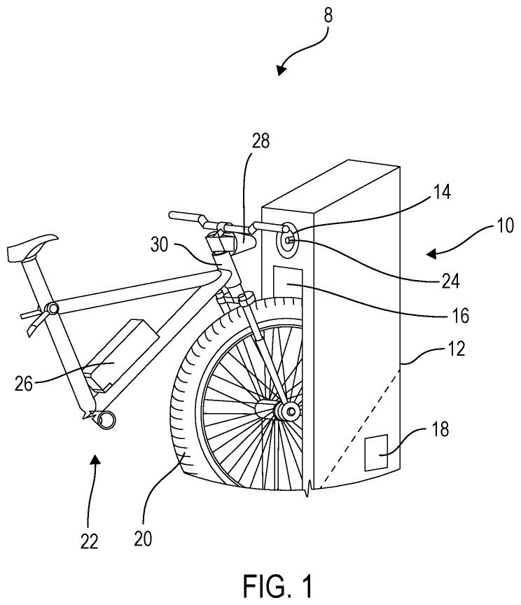

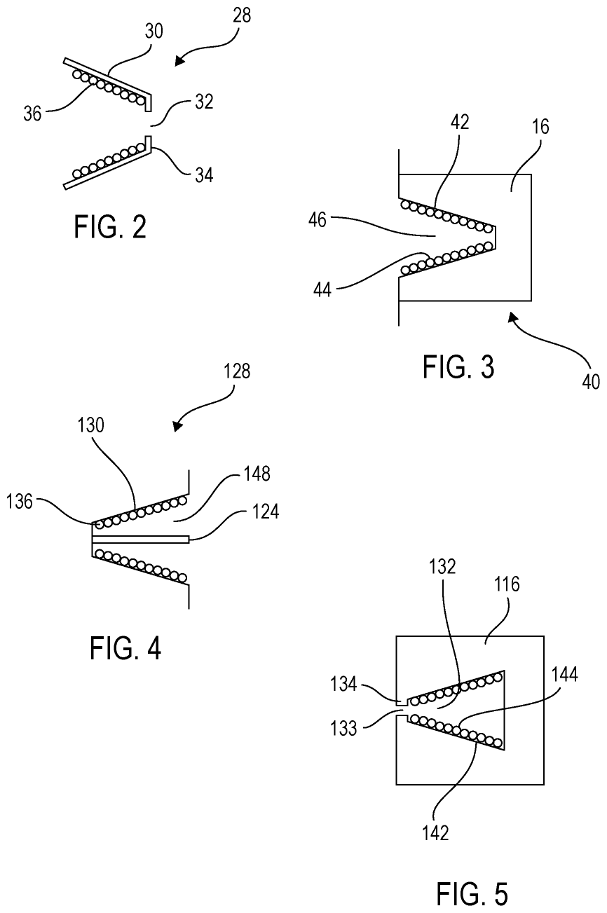

A charging station and LEV combination, generally referred to as 8, is shown in FIG. 1. The charging station, generally referred to as 10, includes a housing 12 with a recess 14 and a slot 16. A power source 18 is housed in the housing. The slot 16 is sized to accept the front wheel 20 of the LEV, generally referred to as 22. A spindle 24 is centrally located in the recess 16 and is part of a locking system. The LEV 22 includes a battery 26 and a receiver module 28 which is mounted on the steering tube 30 of the LEV 22. The battery 26 is in electrical communication with the frustoconical receiver coil 36 (shown in FIG. 2).

As shown in FIG. 2, in one embodiment, the receiver module 28 includes an electrically insulated outer body 30, which is frustoconical in shape. The electrically insulated outer body is preferably a plastic polymeric material, for example, but not limited to acrylonitrile butadiene styrene (ABS), high-density polyethylene (HDPE) or polycarbonate. A centrally located bore 32 extends from the front end 34 of the receiver module 28. Within the electrically insulated outer body 30 is a frustoconical receiver coil 36. As shown in FIG. 3, in this embodiment, the recess 16 houses a transmitter 4 module, generally referred to as 40. The transmitter module 40 includes an electrically insulated liner 42 which is frustoconical or conical. The liner 42 is made of an electrically insulated material, for example, but not limited to ABS, HDPE or polycarbonate plastic polymeric material. Within the electrically insulated liner 42 is a frustoconical transmitter coil 44. The liner 42 defines an interior 46, which is sized to snugly, releasably house the receiver module 28. The frustoconical transmitter coil 44 is in electrical communication with the power source 18.

In an alternative embodiment, as shown in FIG. 4, the receiver module 128 includes an electrically insulated outer body 130, which is frustoconical or conical in shape. Within the electrically insulated outer body 130 is a frustoconical receiver coil 136. A spindle 124 is centrally located in the frustoconical receiver coil 136 and extends through the interior 138. As shown in FIG. 5, in this embodiment, a recess 114 houses the transmitter module 140. The transmitter module 140 includes an electrically insulated liner 142 which is frustoconical. A centrally located bore 132 extends from a central aperture 133 in the front end 134 of the transmitter module 140. Within the electrically insulated liner 142 is a frustoconical transmitter coil 144. The frustoconical transmitter coil 144 is sized to be snugly, releasably housed in the interior 138 of the receiver module 128. The frustoconical transmitter coil 144 is in electrical communication with the power source 18.

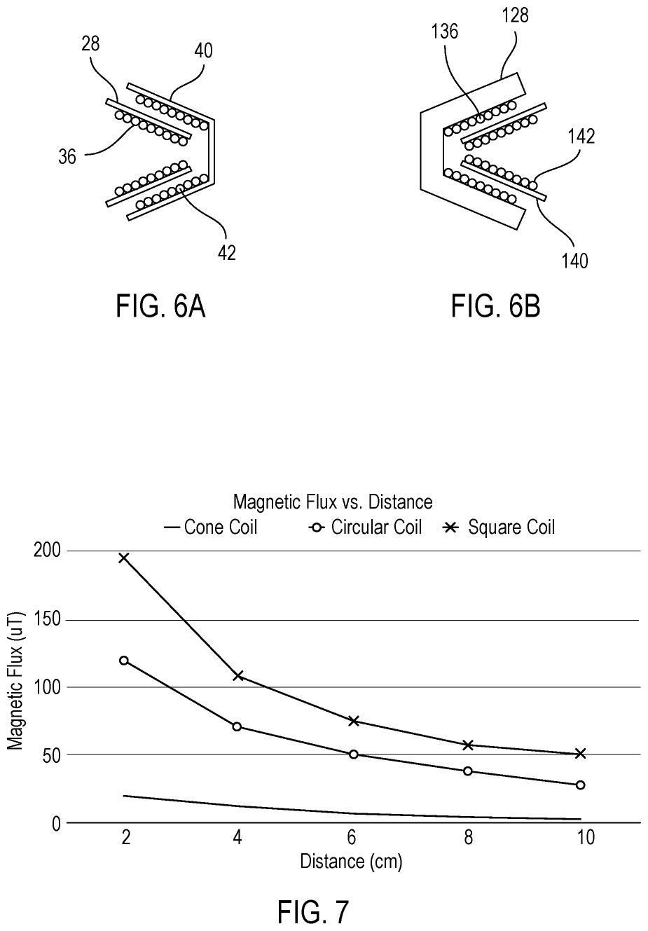

As shown in FIGS. 6A and 6B, regardless of the embodiment, when the receiver modules 28, 128 and the transmitter modules 40, 140 are engaged, the receiver coil 36, 136 and the transmitter coil 42, 142 are in close proximity to one another and are aligned and centered in relation to one another. This maximizes efficiency in charging.

In another embodiment, the LEV may be, for example, but not limited to a bicycle, a scooter, a tricycle, a wheelchair and a two-wheeled, self-balancing personal transporter, for example, a Segway®.

In another embodiment, the receiver module 28, 128 may be configured for attachment to another part of the LEV frame, as long as it can releasably mate with the transmitter module 40, 140. Any suitable clamping member of the receiver module 28, 128 may be used.

The conical coil may be made of, for example, but not limited to copper, aluminium, copper-clad wire and the like and may be printed, etched or made of solid wire or copper clad steel wire.

As shown in FIG. 7, the magnetic flux versus distance is very low for the frustoconical coils as compared to planar circular coils and planar square coils. The three coils have the same number of turns and the same volume of copper. When the first frustoconical coils 36, 136 are mated with the second frustoconical coils 44, 144 the flux leakage is very low and allows the flux to be substantially contained within the coil structure.

In operation, when the receiver module 28, 128 and the transmitter module 40, 140 are mated, the magnetic flux is controlled within the region and the resultant flux pattern is stronger and more pointed than the flux produced by conventional planar coils such as circular or square coils. The pointed flux pattern results in less electromagnetic Interference with the nearby electronic devices in the vicinity of the charging station 12 and limits a user's exposure to magnetic flux.

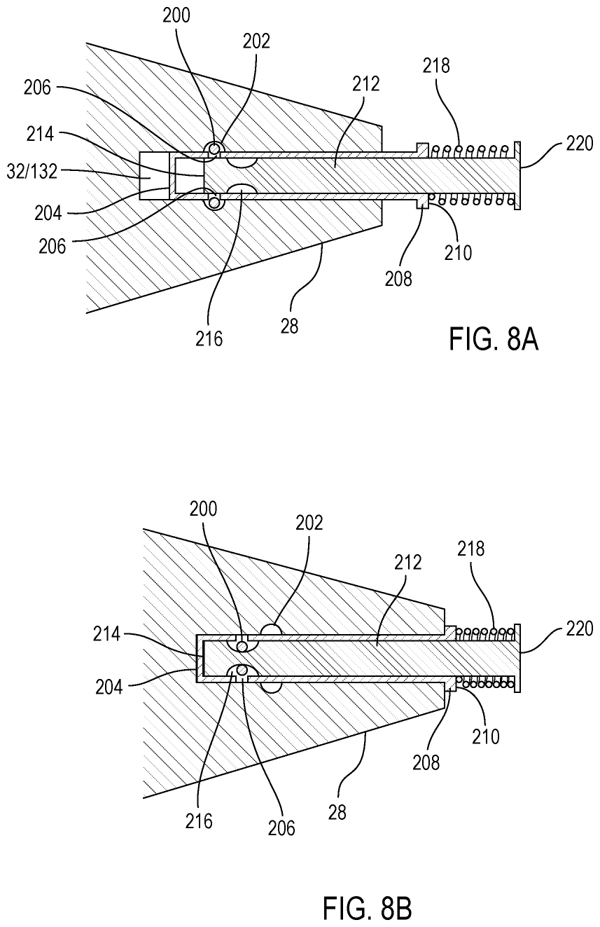

The details of the spindle 24 and locking mechanism are shown in FIGS. 8A and 8B. As shown in FIG. 8A, in the locked position, balls 200 are retained in a groove 202 in the bore 32, 132 of the receiver module 28. The spindle sheath 204 includes apertures 206 that are sized to allow the balls 200 to extend through. The spindle sheath has a collar 208 at the proximal end 210. A plunger 212 is moveably housed in the spindle sheath 204 and has a distal end 214 and a circumferential groove 216 proximate to the distal end 214. A spring 218 is wound around the plunger 212 and extends between the collar 208 and the plunger head 220. The spring 218 keeps the balls 200 releasably housed in the groove 202 of the receiver module 28, locking the receiver module 28 to the charging station 10. It can be seen that there is a space between the spindle sheath 204 and the distal end 214 of the plunger 212, thus the plunger 212 is in the retracted position. As shown in FIG. 8B, to unlock the spindle 24 from the receiver module 28, the spindle sheath 204 is slid forward into the receiver module 28 and the balls 200 return to the circumferential groove 216, allowing the spindle 24 to be removed.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed.

1. A pair of coils for use in inductive charging of a light electric vehicle, the pair of coils comprising a first frustoconical coil and a second frustoconical coil, wherein the first frustoconical coil defines an interior which is sized to accept the second frustoconical coil.

2. The pair of coils of claim 1, wherein the first frustoconical coil includes a liner and a spindle attached to the liner and extending into the interior and the second frustoconical coil includes a frustoconical outer body which includes a front end, the front end defining an aperture with a bore extending therefrom, the frustoconical outer body sized to be accepted by the second frustoconical coil and the aperture and bore sized to accept the spindle.

3. The pair of coils of claim 2, wherein the spindle includes a spindle sheath which includes a circumferential groove, a plunger which is slidably housed in the spindle sheath and includes circumferentially disposed apertures, a plurality of balls which are releasably housed in the circumferential groove and which are sized to partially extend through the apertures and a spring which biases the plunger from the spindle sheath.

4. The pair of coils of claim 3, wherein the bore includes a circumferential groove which is sized to accept the plurality of balls.

5. A combination of a light electric vehicle and a charging station, wherein: the light electric vehicle includes a receiver module, the receiver module comprising a frustoconical insulating body and a frustoconical receiver coil which is housed in the frustoconical insulating body; and the charging station comprising a housing which defines a recess, a transmitter module which is housed in the recess and includes a liner and a frustoconical or conical transmitter coil which is housed in the liner and defines an interior, the interior sized to accept the receiver module.

6. The combination of claim 5, wherein the housing of the charging station defines a slot for accepting at least a portion of the light electric vehicle such that the receiver module can be mated with the transmitter module.

7. The combination of claim 6, wherein the light electric vehicle includes a steering tube and receiver module mounted on the steering tube.

8. The combination of claim 7, wherein the transmitter module further includes a spindle which is attached to the liner and extends into the interior and the receiver module includes a front end which defines an aperture with a bore extending therefrom, the aperture and bore sized to accept the spindle.

9. The combination of claim 8, wherein the spindle includes a spindle sheath which includes a circumferential groove, a plunger which is slidably housed in the spindle sheath and includes circumferentially disposed apertures, a plurality of balls which are releasably housed in the circumferential groove and which are sized to partially extend through the apertures and a spring which biases the plunger from the spindle sheath.

10. The combination of claim 9, wherein the bore includes a circumferential groove which is sized to accept the plurality of balls.

11. A method of charging a light electric vehicle, the method comprising: a user selecting a light electric vehicle including a battery and a frustoconical receiver module, the frustoconical receiver module including a frustoconical receiver coil which is in electrical communication with the battery; the user selecting a charging station, the charging station including a housing which defines a recess, a transmitter module which is housed in the recess and includes a liner and a frustoconical or conical transmitter coil which is housed in the liner and defines an interior, the interior sized to accept the receiver module; the user sliding the receiver module into the transmitter module; and the charging station powering the frustoconical or conical transmitter coil, thereby charging the battery of the light electric vehicle.

12. The method of claim 11, further comprising locking the receiver module to the transmitter module prior to charging the battery of the light electric vehicle.

13. The method of claim 12, further comprising unlocking the receiver module from the transmitter module after charging the battery of the light electric vehicle.
